(19) United States
(12) Patent Application Publication
(10) Pub. No.: US 2024/0412292 A1
(43) Pub. Date: Dec. 12, 2024

(54) TRUST MANAGEMENT SYSTEM

(71) Applicant: National Trust Council, General Incorporated Association, Tokyo (JP)

(72) Inventor: Masaki NAKAMOTO, Tokyo (JP)

(73) Assignee: National Trust Council, General Incorporated Association, Tokyo (JP)

(21) Appl. No.: 18/386,592

(22) Filed: Nov. 2, 2023

(30) Foreign Application Priority Data
Jun. 9, 2023 (JP) 2023-95917

(51) Int. Cl. G06Q 40/06

(52) U.S. Cl. CPC G06Q 40/06

(57) ABSTRACT

The trust management system CS have: a management server 100 storing trust property information including contract details information, the contract details information including a trustor information, a trustee information, a beneficiary information, and the contract details of the trust property; and, a program PG that is stored in a storage unit 120. The program PG causes the management server 100 to execute: an extraction function that extracts trustee identification information, beneficiary identification information, and trust property identification information; a generation function that generates the trustee certification information and the trust property identification information, and beneficiary certification information; a notification function that notifies the trustor terminal, the trustee terminal, and the beneficiary terminal; and, a transmission or browsing function that causes the trustee certification information, and the beneficiary certification information to be transmitted or viewed by a terminal that sent a transmission or browsing request.

### CROSS-REFERENCE TO RELATED APPLICATIONS

This application claims priority to Japanese Patent Application No. 2023-95917 filed on Jun. 9, 2023 and which is pending. The entire disclosure of Japanese Patent Application No. 2023-95917 is hereby incorporated herein by reference for all purposes.

### FIELD OF THE INVENTION

The present invention relates to a trust management system.

### BACKGROUND

Trusts are known as a system in which people entrust their assets to a trusted person or corporation and have them manage, and inherit their assets for a specific person or themself in accordance with the purpose they have determined. Trusts can be broadly classified into two types: commercial trusts and civil trusts. Commercial trusts are those in which trust banks and trust companies take on the role of trustees as part of their business to earn trust fees, and civil trusts are basically, an individual or corporation plays the role of a trustee without receiving trust fees.

A trust consists of three roles: trustor, trustee, and beneficiary, but it is possible for the trustor to become the beneficiary, and the contents of the contract vary widely. Among these, especially in civil trusts, as time passed after the trust contract was signed or inheritance occurred, the roles of each person became unclear among the parties, leading to situations where assets were not fully utilized. To confirm each person's role in the trust agreement, it is sufficient to check the contents of the trust agreement, but the contents of the trust agreement are complex, making it difficult for each person to understand their own role.

Here, although it is not a technology related to trusts, Japanese Unexamined Patent Application Publication No. Hei No. 8-58271 discloses a used car price list. The used car price list includes a vehicle type display that displays the car model, a new car release date display, a standard mileage display, a monthly standard mileage display, and a color-specific unit mileage evaluation value display. According to the used car price list, it is possible to optimize the price by performing a monetary evaluation of the used car based on each display. As described above, although technology has been developed to organize various information to make it easier to view in used car price lists, etc., such technology has not yet been developed in the field of trust contracts.

### SUMMARY

### Problems to be Solved by the Invention

The purpose of the present invention is to separate trust contract information into trustee certification information (or trustee certificate) and beneficiary certification information (beneficiary certificate) and provide them to the trustor, trustee, and beneficiary.

### Means Used to Solve the Above-Mentioned Problems

A trust management system of the first aspect includes:
a management server storing and managing trust property information including contract details information in its own storage unit, and connected to a communication network, the contract details information including (1) a trustor information regarding the trustor of trust property, (2) a trustee information regarding the trustee, (3) a beneficiary information regarding the beneficiary, and (4) the contract details of the trust property; and,
a program that is stored in the storage unit, is available to the management server, and enables information transmission between the management server and at least one of a trustor terminal used by the trustor, a trustee terminal used by the trustee, and a beneficiary terminal used by the beneficiary via the communication network,
   wherein the program causes the management server to execute
a storage function that stores the trust property information and its reception date and time in the storage unit;
an extraction function that extracts, from the trust property information stored in the storage unit by the storage function, trustee identification information that identifies the trustee, beneficiary identification information that identifies the beneficiary, and trust property identification information that identifies the trust property from the trust property information;
a generation function that generates, assuming that each of which the reception date and time is contract date, trustee certification information including the trustee identification information and the trust property identification information, and beneficiary certification information including the beneficiary identification information and the trust property identification information from the trustee identification information, the beneficiary identification information, and the trust property identification information extracted by the extraction function;
a notification function that, after the generation function generates the trustee certification information and the beneficiary certification information, notifies the trustor terminal, the trustee terminal, and the beneficiary terminal of completion of generating by the generation function; and,
a transmission or browsing function that causes, after the completion is notified by the notification function, the trustee certification information, and the beneficiary certification information to be transmitted or viewed by a terminal that sent a transmission or browsing request, assuming that the reception date and time is the contract date via an application running on the trustor terminal, the trustee terminal, or the beneficiary terminal, in response to a transmission or viewing request sent from the trustor terminal, the trustee terminal, or the beneficiary terminal.

A trust management system of the second aspect has the following features on the premise of the first aspect:

The trust property identification information is composed of first information regarding subject of the trust property and second information regarding other than the subject;
the generation function divides the trust property identification information into the first information and the second information, and generates the trustee certification information and the beneficiary certification information; and,
the sending or browsing function divides, respectively, the trustee certification information and the beneficiary certification information into (A) the trustee identification information, the first information, and the second information; and (B) the beneficiary identification information, the first information, and the second information, and allows the terminal that sent a sending or browsing request to send or view (A) the trustee identification information, the first information, and the second information; and (B) the beneficiary identification information, the first information, and the second information.

A trust management system of the third aspect has the following features on the premise of the second aspect:
the program causes the management server to execute
a mailing function that prints the trustee certification information and beneficiary certification information using a printing machine, creates a trustee certificate and beneficiary certificate, and mails the trustee certificate and the beneficiary certificate to a location specified by the terminal that sent a mailing request, in response to the mailing request sent from the trustor terminal, the trustee terminal, and the beneficiary terminal via an application running on the trustor terminal, the trustee terminal, and the beneficiary terminal after the completion is notified by the notification function.

A trust management system of the fourth aspect has the following features on the premise of the first aspect.
the trust management system can transmit a modification request of the trustee certification information from the trustor terminal to the management server via an application running on the trustor terminal, the trustee terminal, and the beneficiary terminal after the completion is notified by the notification function.

The generation function modifies the beneficiary certification information based on the modification request; and,
the sending or browsing function allows the trustee certification information and the beneficiary certification information modified based on the modification request, assuming that the date and time when the modification request was sent is modification date, to send or view to the trustor terminal, the trustee terminal, and the beneficiary terminal after the beneficiary certification information is modified.

A trust management system of the fifth aspect has the following features on the premise of the third aspect:
the trustee certificate and the beneficiary certificate are each a piece of paper with characters printed on both sides, and,
the beneficiary certificate has the beneficiary identification information and the first information printed on one side, and the second information on the other side.

A trust management system of the sixth aspect has the following features on the premise of the first aspect:
if the contract for the trust property includes a money trust, the management server can receive withdrawal information for the money trust from a deposit server that manages deposit account for the money trust via the communication network; and,
when the management server receives the withdrawal information of the deposit account from the deposit server, the notification function notifies the trustor terminal, the trustee terminal, and the beneficiary terminal of the withdrawal information.

A trust management system of the seventh aspect has the following features on the premise of any one of the first aspect to the sixth aspect:
the program is set to be operable only when information on a personal number card connected to the trustor terminal and the trustee terminal and set in a card reader matches registered information of the trustor or the trustee.

According to the trust management system of the first aspect, the trust contract information is divided into trustee certification information (or trustee certificate) and beneficiary certification information (beneficiary certificate), and the information is provided to the trustor, trustee, and beneficiary.

According to the trust management system of the second aspect, the organized information can be viewed using the terminal that sent the transmission or viewing request.

According to the trust management system of the third aspect, the organized trustee certification information (or trustee certificate) and beneficiary certification information (beneficiary certificate) are mailed to the person using the terminal that sent the mailing request.

According to the trust management system of the fourth aspect, the modified contents are reflected in the trustee certification information (or trustee certificate) and beneficiary certification information (beneficiary certificate).

According to the trust management system of the fifth aspect, the printed trustee certification information (or trustee certificate) and beneficiary certification information (beneficiary certificate) are respectively arranged on the front and back sides.

According to the trust management system of the sixth aspect, when the contract details of the trust property include a money trust, the withdrawal information of the deposit account is shared with each party concerned.

According to the trust management system of the seventh aspect, security is enhanced.

Furthermore, these trust management systems above can provide a means for easily confirming the contents of a trust contract. As a result, it is possible to promote the use of civil trusts among people who are not familiar with trusts in their normal daily lives, such as family members, and it is expected that economic activity will be stimulated. For example, according to a civil trust, the parent is the trustor, the child is the trustee, and the grandchild is the beneficiary, and the child (the trustee) manages the trust property transferred from the parent (the trustor) according to a certain purpose. Users can manage, dispose of, etc., and give the trust assets and the profits generated from them to your grandchildren (beneficiaries). In other words, it is possible for parents to freely manage their assets even while they are still alive, entrusting the right to manage and dispose of assets to trusted children, etc., and to give the generated profits to desired grandchildren, etc. In addition, civil trusts allow you to determine the details of inheritance and determine who will inherit assets up to the next two generations, and provide asset management services for people who have difficulty managing their assets, such as the elderly and dementia patients. It is also possible to do so. According to such civil trusts, assets can be managed, operated, disposed of, inherited, etc. smoothly, so the spread of civil trusts is expected to stimulate economic activity.

### BRIEF DESCRIPTION OF THE DRAWINGS

These drawings illustrate certain aspects of some of the embodiments of the present invention and should not be used to limit or define the invention.

FIG. 1 is a diagram showing the surface of a display object (a trustee certificate) that displays a trust certificate.

FIG. 2 is a diagram showing the back side of the display object (the trustee certificate) that displays a trustee certificate.

FIG. 3 is a diagram showing the surface of a display object (a beneficiary certificate) that displays a beneficiary certificate.

FIG. 4 is a diagram showing the back side of the display object (the beneficiary certificate) that displays a beneficiary certificate.

FIG. 5 is a schematic diagram of a trust management system CS of this embodiment.

FIG. 6 is a flow diagram of a program PG1 that executes the basic functions of this embodiment.

FIG. 7 is a diagram showing a user terminal on which a certificate is displayed via the application of this embodiment.

FIG. 8 is a flow diagram of a program that executes an additional function (mailing function) of this embodiment.

FIG. 9 is a flow diagram of a program that executes another additional function (correction function) of this embodiment.

FIG. 10A is a schematic diagram of a trust management system CSc that executes another additional function (withdrawal notification function in the case of a money trust) of this embodiment.

FIG. 10B is a flow diagram of a program that executes another additional function (withdrawal notification function in the case of money trust) of this embodiment.

### DETAILED DESCRIPTION

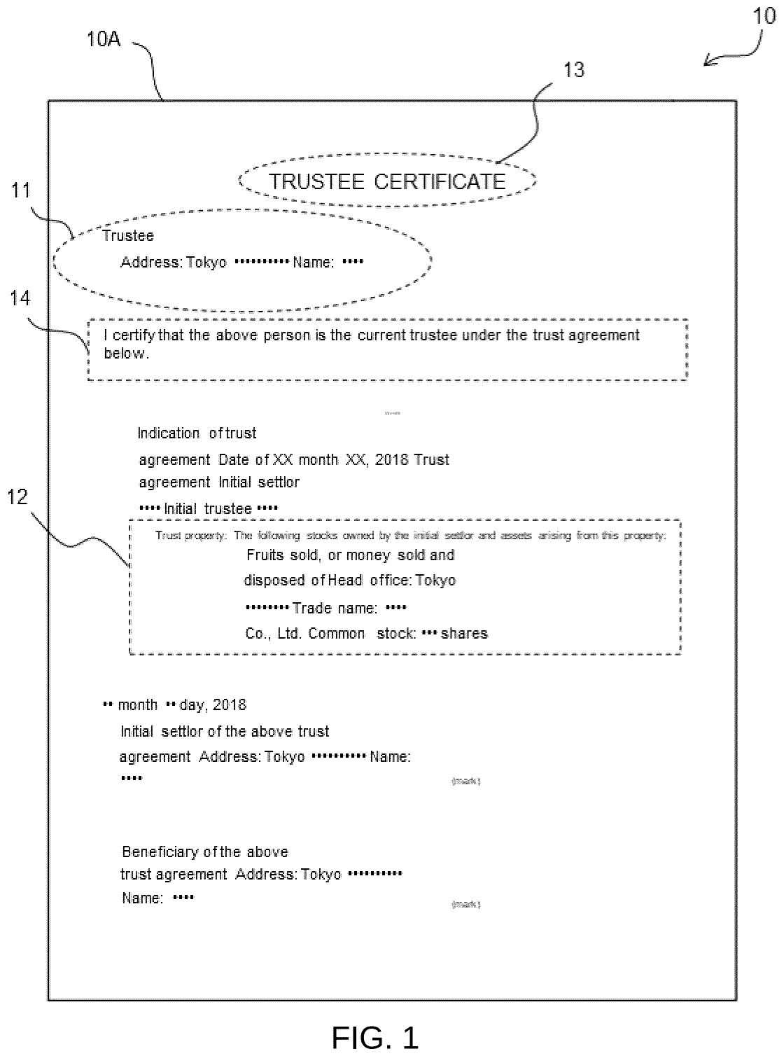

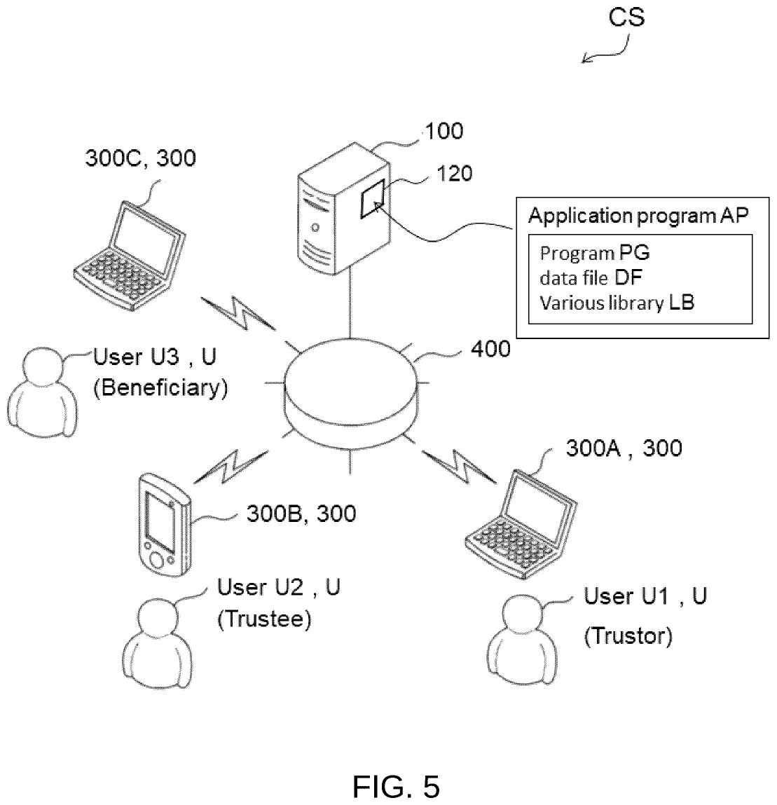

This embodiment will be described below. First, the certificates (the trustee certificate 10 and the beneficiary certificate 20) of this embodiment will be explained with reference to FIGS. 1 to 4. Next, the programs PG1 to PG4 and the trust management system CS of this embodiment will be explained with reference to FIGS. 5 to 7. Next, modifications of this embodiment will be described.

### Certificate

### Trustee Certificate

FIG. 1 is a diagram showing a front surface 10A (an example of one side) of a display object (the trustee certificate 10) that displays a trustee certificate. The trustee certificate 10 includes, for example, a trustee display section 11 (an example of trustee identification information) that displays information that identifies the trustee, and a trust property display section 12 (an example of the first information) that displays information that identifies trust assets.

The trustee display section 11 is not particularly limited as long as it displays information that identifies the trustee, but preferably displays the trustee's name and address or residence, for example. This makes it easier to identify the trustee.

The trust property display section 12 is a part where information specifying trust property (an example of trust property identification information) is displayed. The trust property display section 12 makes it easy to understand the contents of the trust property. Examples of trust assets include stocks, securities such as bonds, real estate, money, and intellectual property.

It is preferable that the trustee certificate 10 includes a trustee certification section 14 in which a description certifying that the person described in the trustee display section 11 is the trustee. Furthermore, in this case, it is preferable that the trustee certificate 10 includes a space for the trustor's name and seal, a space for the trustor's signature, a space for the name and seal of the beneficiary, a space for the beneficiary's signature, and the like.

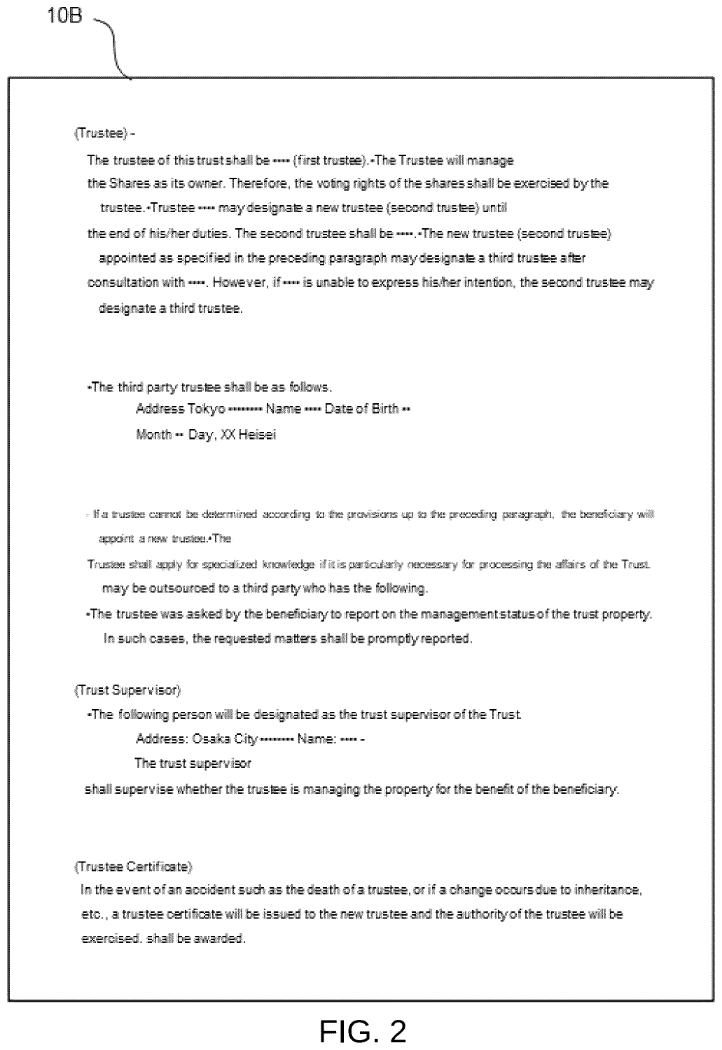

When the trustee certificate 10 is a medium like a sheet, it is preferable that the surface 10A of the medium includes the trustee display section 11, the trust property display section 12, and the trustee certificate title section 13. Moreover, as shown in FIG. 2, it is preferable that a partial excerpt of the trust contract (an example of the second information) is written on the back surface 10B of the medium.

The trustee certificate title section 13 indicates that the medium is the trustee certificate 10.

By including a trustee display section 11, a trust property display section 12, and a trustee certificate title section 13 on the surface 10A of the medium, it is easy for each person to confirm the contents of the trustee and the trust property briefly. In addition, the back side 10B of the medium includes excerpts of matters related to the right of trusteeship in the trust contract, so that the trustee can access information related to his or her role without having to read and decipher a complicated trust contract. This can be made easier for each person to confirm.

FIG. 2 is a diagram showing the back side 10B of the display object (the trustee certificate 10) that displays the trustee certificate. Examples of the partial excerpts of the trust contract written on the back side 10B of the medium include the following (1) to (5), as shown in FIG. 2.
(1) New trustee designation matters regarding designation of second trustee, third trustee, etc.
(2) New trustee specification matters specifying the second trustee, third trustee, etc.
(3) Trust supervisor designation matters regarding trust supervisor designation.
(4) Trust supervisor specific matters that identify the trust supervisor.
(5) Trust property management status report items stipulated to be reported when the trustee is requested by a beneficiary to report on the management status of the trust property.

As shown in FIG. 2, fiduciary certificate issuance matters regarding an agreement to issue a new fiduciary certificate when the fiduciary changes may be described.

If the trust property is stocks, for example, it is preferable that voting rights attribution matters regarding the attribution of voting rights be described. Voting rights of stocks do not have a monetary value and are not independent trust property, so when stocks are entrusted, the ownership of voting rights tends to be unclear. By doing so, it is possible to clarify where voting rights belong.

### Beneficiary Certificate

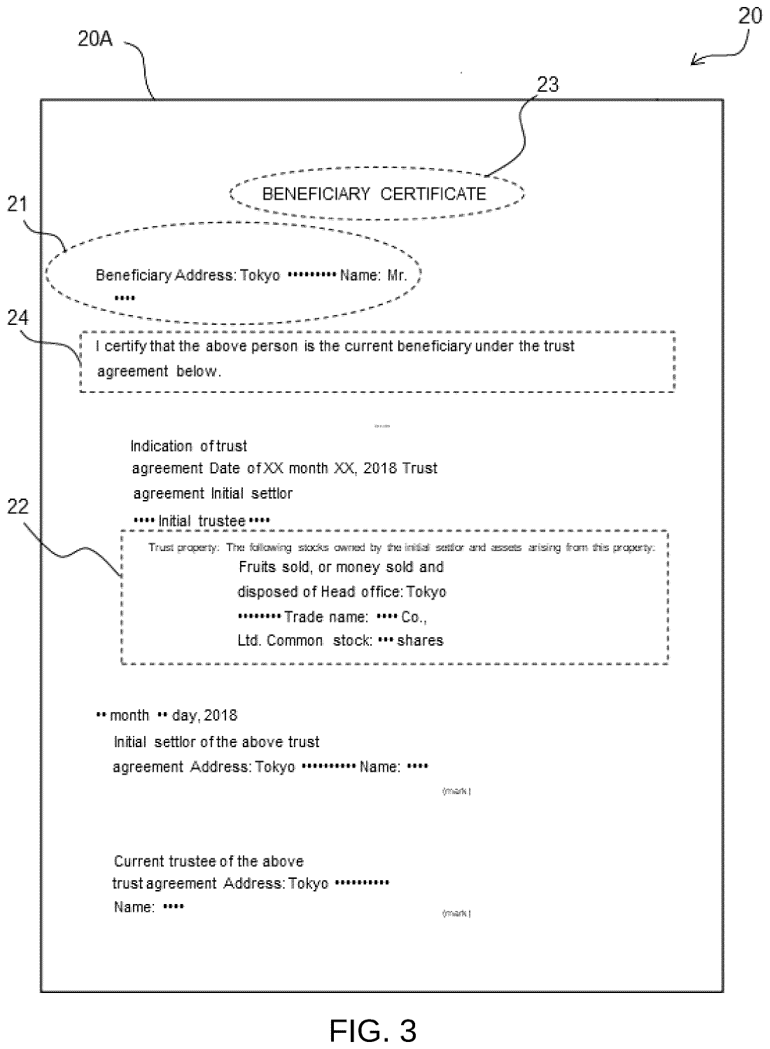

FIG. 3 is a diagram showing the front surface 20A of the display object (the beneficiary certificate 20) that displays the beneficiary certificate. The beneficiary certificate 20 includes a beneficiary display section 21 that displays information that specifies the beneficiary, and a trust property display section 22 (another example of the first information) that displays information that specifies the trust property.

The beneficiary display section 21 is not particularly limited as long as information identifying the beneficiary is displayed, but preferably displays the beneficiary's name and address or residence, for example. This makes it easier for uses to identify the beneficiary.

The trust property display section 22 is a part where information identifying trust property (another example of trust property identification information) is displayed. The trust property display section 22 makes it easy for each person to understand the contents of the trust property. Examples of trust assets include stocks, securities such as bonds, real estate, money, and intellectual property.

It is preferable that the beneficiary certificate 20 includes a beneficiary certification part 24 in which a statement certifying that the person described in the beneficiary display part 21 is a beneficiary is written. Furthermore, in this case, it is preferable that the beneficiary certificate 20 includes a space for the trustor's name and seal, a space for the trustor's signature, a space for the name and seal of the trustee, a space for the trustee's signature, and the like.

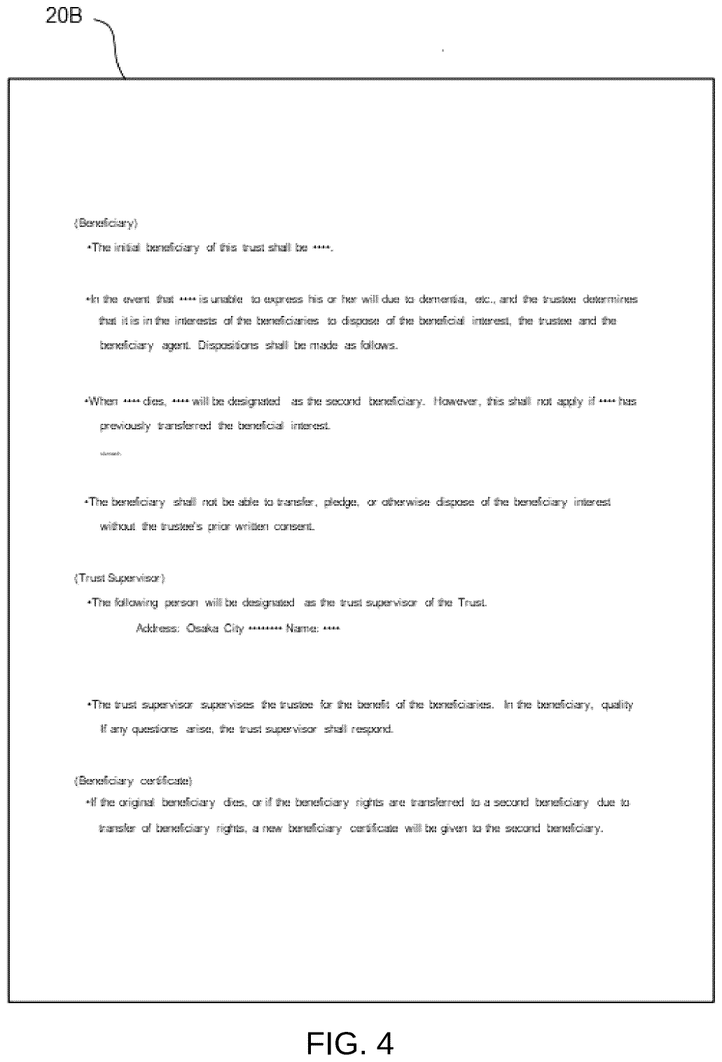

When the beneficiary certificate 20 is a medium like a sheet, it is preferable that the surface 20A of the medium includes a beneficiary display section 21, a trust property display section 22, and a beneficiary certificate title section 23. Here, FIG. 4 is a diagram showing the back side 20B of the display object (the beneficiary certificate 20) that displays the beneficiary certificate. In the beneficiary certificate 20, it is preferable that some excerpts of the trust contract are written on the back side 20B.

The beneficiary certificate title section 23 indicates that the medium is the beneficiary certificate 20.

By including the beneficiary display section 21, the trust property display section 22, and the beneficiary certificate title section 23 on the surface 20A of the medium, it is easy for each person to confirm the beneficiary and the contents of the trust property briefly. Furthermore, by listing some excerpts of the matters related to the beneficiary rights in the trust contract on the back side 20B of the medium, beneficiaries can confirm information related to their role without having to read and decipher the complicated trust contract.

Examples of the partial excerpts of the trust contract written on the back side 20B of the medium include the following (1) to (5), as shown in FIG. 4.
(1) New beneficiary designation matters regarding designation of second beneficiary, etc.
(2) New beneficiary identification matters that identify the second beneficiary, etc.
(3) Trust supervisor designation matters regarding trust supervisor designation.
(4) Trust supervisor specific matters that identify the trust supervisor.
(5) Matters related to disposal of beneficial interests.

As shown in FIG. 4, beneficiary certificate issuance matters regarding an agreement to issue a new beneficiary certificate when the beneficiary changes may be described.

### A Set of Trustee Certificate Display Object and Beneficiary Certificate Display Object

The trustee certificate 10 and the beneficiary certificate 20 may be set. The trustee certificate 10 and the beneficiary certificate 20 do not necessarily need to be kept by the trustee and the beneficiary, respectively. For example, a civil trust consulting company etc. can store a set of the trustee certificate 10 and the beneficiary certificate 20 may be stored. This makes it possible to avoid the risk of loss of the trustee certificate 10 and beneficiary certificate 20 by the trustee, beneficiary, etc. Furthermore, since the set of the trustee certificate 10 and the beneficiary certificate 20 are two separate displays, when a consulting company etc. receives an inquiry from a trustee, beneficiary, etc. regarding the role of each person, etc., each person's role can be explained by moving each separated display object. This makes it easier for the trustee and beneficiaries to imagine the relationship of ownership of rights, the trust assets, and the flow of profits, making it easier for each person to understand their roles.

### A Set of Trustee Certificate, Beneficiary Certificate, and Trust Agreement

The trustee certificate 10, beneficiary certificate 20, and trust contract may be set. By storing the trustee certificate 10, beneficiary certificate 20, and trust agreement together, it is possible to check the contents not stated in the trustee certificate 10 and beneficiary certificate 20 in the trust agreement. The trust agreement does not need to be the original; it may be a copy of the trust agreement.

The above is the description of the trustee certificate 10 and beneficiary certificate 20 of this embodiment.

### Program and Trust Management System

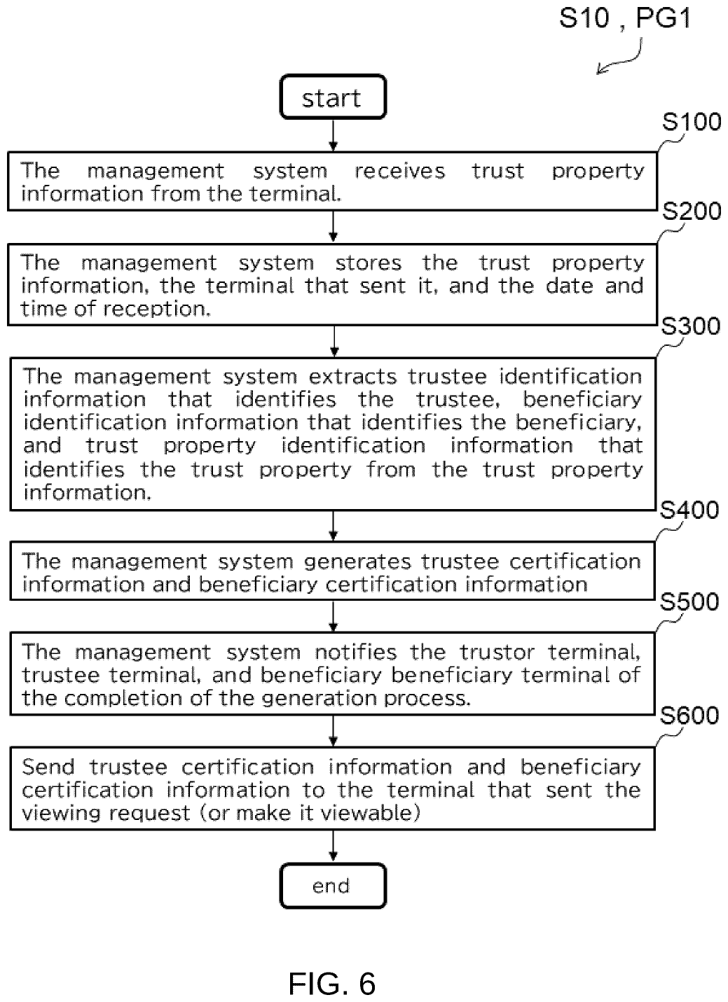

Next, the basic functions of the program PG1 and the trust management system CS of this embodiment will be explained with reference to FIGS. 5, 6, and the like. Here, FIG. 5 is a schematic diagram of the trust management system CS. FIG. 6 is a flow diagram (algorithm S10 diagram) of the program PG1 that executes the basic functions for operating the trust management system CS of this embodiment.

As shown in FIG. 5, the trust management system CS includes a management server 100, a plurality of user terminals 300 (user terminals 300A, 300B, and 300C are shown as representative examples in each figure), and a communication network 400 (as an example, Internet) and an application program AP.

### Management Server

The management server 100 owns trust property information including trustor information regarding the trustor U1, trustee information regarding the trustee U2, beneficiary information regarding the beneficiary U3, and contract content information regarding the contract content of the trust property. It is stored in the storage unit 120 and managed. Furthermore, the program PG1 included in the application program AP is connected to the communication network 400 between the trustor terminal 300A used by the trustor U1, the trustee terminal 300B used by the trustee U2, and the beneficiary terminal 300C used by the beneficiary U3. The program PG1 enables information transmission between the trustor terminal 300A, the trustee terminal 300B, and the beneficiary terminal 300C via the communication network 400. The program PG1 causes the management server 100 to execute a plurality of functions to be described later.

### Multiple User Terminals

The plurality of user terminals 300 are information devices for each user, such as the trustor U1, the trustee U2, the beneficiary U3, etc., to use an application program AP executed based on the program PG1. The information devices include smartphones, tablets, personal computers, and other computers. Users U1, U2, . . . are those who have registered in the trust management system CS to use the application program AP. The registered information (identifying information such as name, address, telephone number, email address, etc.) of the trustor U1, trustee U2, beneficiary U3, etc. is stored and managed in the storage unit 120 through the respective registration procedures.

### Application Program

The application program AP is stored in the storage unit 120 of the management server 100, as shown in FIG. 5. The application program AP includes a program PG1, a data file DF, and various libraries LB.

The application program AP may be installed and available on each user terminal 300 (for example, a smartphone application), or may be stored in the management server 100 and available for use via a web browser.

Next, the program PG1 of this embodiment will be explained. For example, the program PG1 causes the management server 100 to execute the following basic functions. Here, it should be noted that the program PG1 and the trust management system CS including the program PG1 are included in the technical scope of the present invention as long as they are each in a form that can realize the basic functions described below. From another perspective, it should be noted that the embodiments included in the present invention do not need to include additional functions described below as essential components.

### Basic Functions

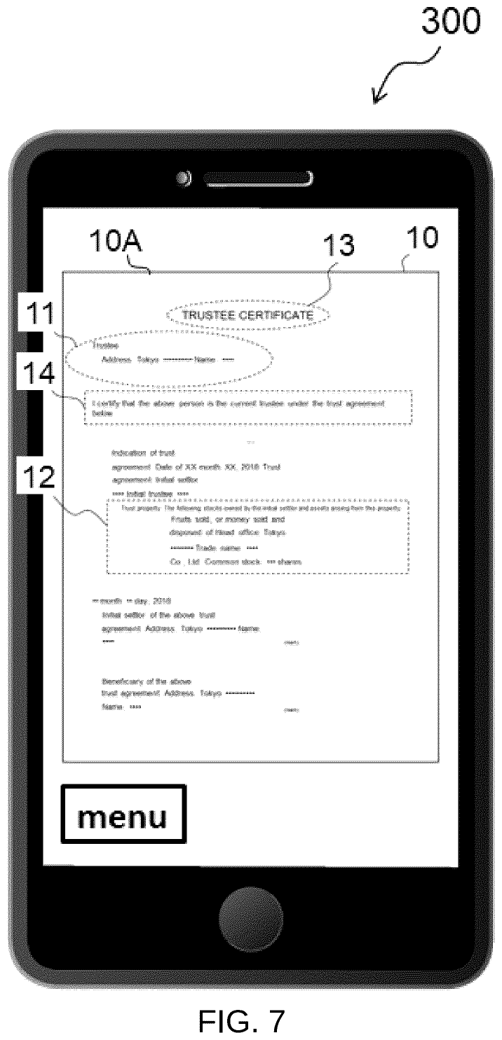

The basic functions are a reception function, a storage function, an extraction function, a generation function, a notification function, and a transmission or viewing function. Here, FIG. 7 is a diagram showing the user terminal 300 on which a certificate is displayed via the application program AP.

The basic functions will be explained with reference to FIGS. 5 to 7.

### Reception Function

This function causes the management server 100 to receive trust property information input and transmitted to the trustor terminal 300A or the trustee terminal 300B via the application program AP running on the trustor terminal 300A and the trustee terminal 300B (see S100 in FIG. 6).

The premise of executing this function is that the trustor U1 uses the trustor terminal 300A or the trustee U2 uses the trustor terminal 300B to create a trust account via the interface (a user interface UI by the application program AP) displayed on the screen of each terminal.

The interface UI of this function allows a person who inputs information regarding trust property to be guided and to input information even if he or she does not know the format of the trust agreement.

### Storage Function

This function causes the storage unit 120 to store the trust property information received by the receiving function, the terminal from which the trust property information was input and transmitted, and the date and time of reception thereof (see S200 in FIG. 6).

### Extraction Function

This function extracts, from the trust property information stored in the storage unit 120 by the storage function, (1) trustee identification information that identifies the trustee U2, (2) beneficiary identification information that identifies the beneficiary U3, and (3) trust property identification information that identifies the trust property (See S300 in FIG. 6).

### Generation Function

This function generates, assuming that each of which the reception date and time is contract date, trustee certification information including the trustee identification information and the trust property identification information, and beneficiary certification information including the beneficiary identification information and the trust property identification information from the trustee identification information, the beneficiary identification information, and the trust property identification information extracted by the extraction function (see S400 in FIG. 6).

### Notification Function

This function notifies, after the generation function generates the trustee certification information and the beneficiary certification information, the trustor terminal 300A, the trustee terminal 300B, and the beneficiary terminal 300C of completion of generating by the generation function (See S500 in FIG. 6). With this function, a person other than the person who inputted the information on the trust property is given an opportunity to share the input information on the trust property.

### Send or View Function

This function causes, after the completion is notified by the notification function, the trustee certification information, and the beneficiary certification information to be transmitted or viewed by a terminal that sent a transmission or browsing request, assuming that the reception date and time is the contract date via an application running on the trustor terminal 300A, the trustee terminal 300B, or the beneficiary terminal 300C, in response to a transmission or viewing request sent from the trustor terminal 300A, the trustee terminal 300B, or the beneficiary terminal 300C (see S600 in FIG. 6 and FIG. 7).

This function allows the person who made the transmission or viewing request to check information regarding the trust property.

As described above, the trust management system CS of this embodiment has the following effects. That is, according to the trust management system CS, the trust contract information is divided into trustee certification information (or trustee certificate) and beneficiary certification information (beneficiary certificate) and provided to the trustor U1, the trustee U2, and the beneficiary U3. Furthermore, according to the trust management system CS, the organized information can be viewed using the terminal that sent the transmission or viewing request.

The above is the description of the trust management system CS of this embodiment.

### Additional Functions

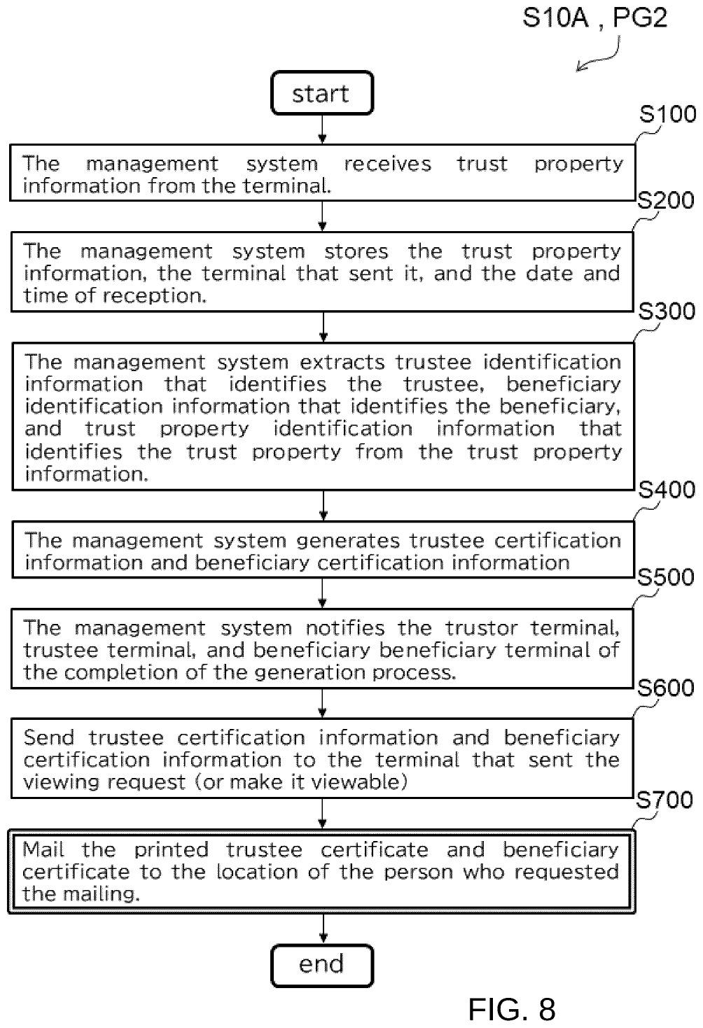

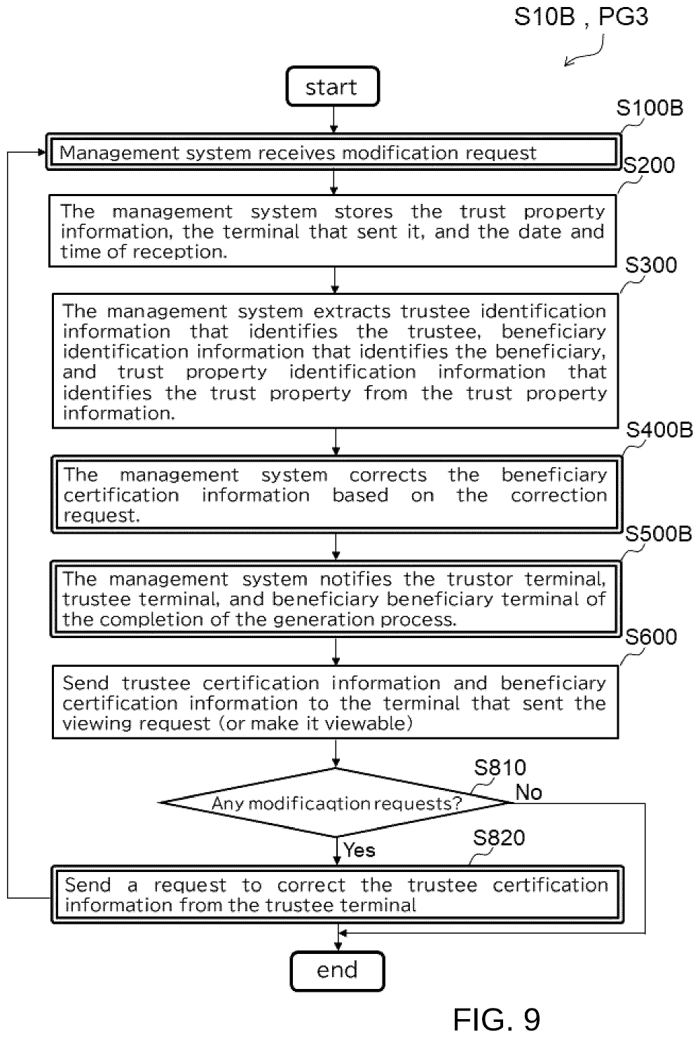

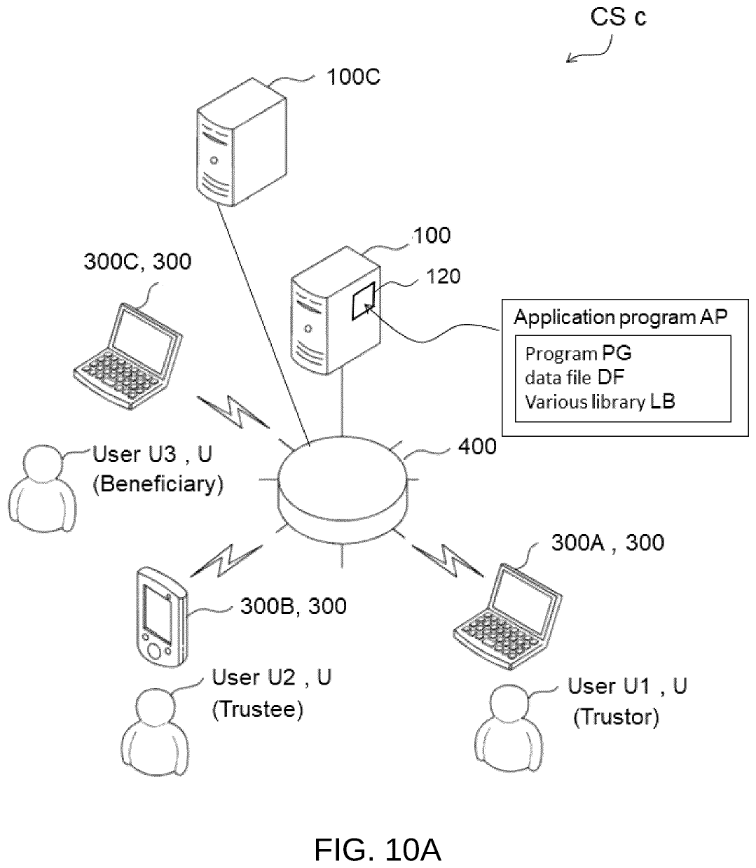

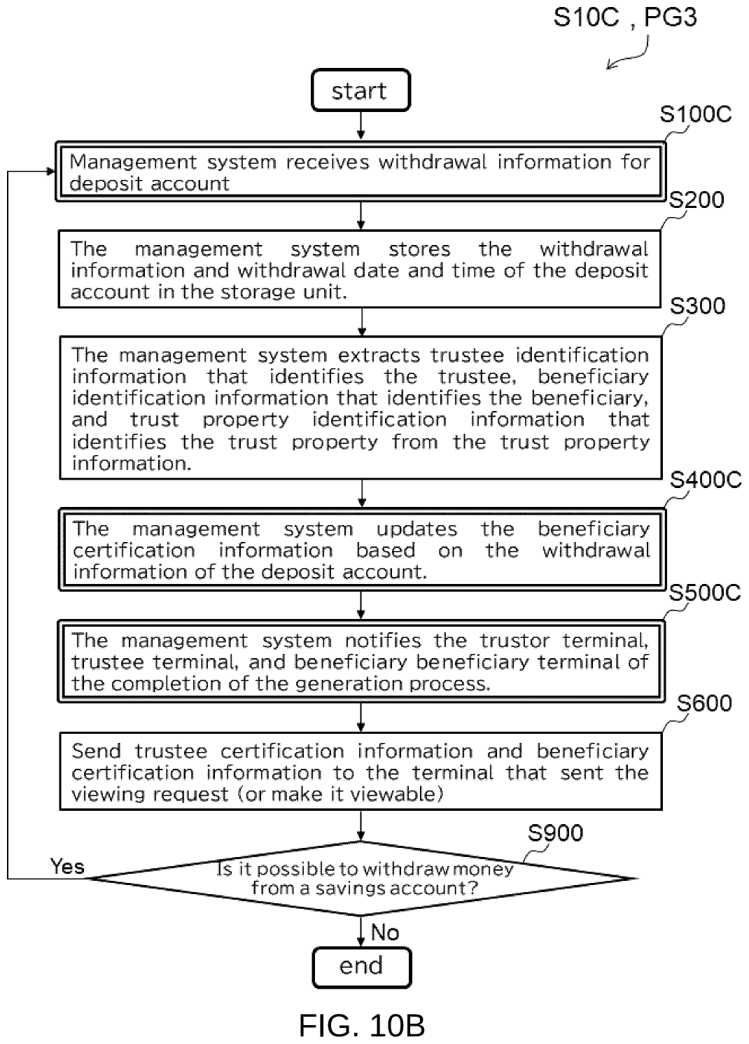

Next, the additional functions will be explained. Here, FIG. 8 is a flow diagram (diagram of algorithm S10A) of a program that executes one of the additional functions (mailing function) of this embodiment. FIG. 9 is a flow diagram (algorithm SOB diagram) of a program that executes another additional function (modification function) of this embodiment. FIG. 10A is a schematic diagram of a trust management system CSc that executes another additional function (withdrawal notification function in the case of a money trust) of this embodiment. FIG. 10B is a flow diagram (algorithm SOC) of a program that executes another additional function (withdrawal notification function in the case of money trust) of this embodiment.

### Mailing Function

In this function, after the completion of the generation process (see S400 in FIG. 8) is notified by the notification function (see S500 in FIG. 8), in response to mail requests sent from one of the trustor terminal 300A, the terminal 300B and the beneficiary terminal 300C, the trustee certificate 10 and the beneficiary certificate 20 are created by printing the trustee certification information and beneficiary certification information using a printing machine (not shown). Then, the trustee certificate 10 and beneficiary certificate 20 (see FIGS. 1 to 4) are sent to the location specified by the person U1, U2, or U3 (see FIG. 5) who uses the terminal that sent the mailing request.

Here, as shown in FIG. 8, this function (S700) is executed after the basic function (see FIG. 6) is executed.

Furthermore, the trustee certificate 10 and beneficiary certificate 20 that are mailed by this function are each a piece of paper with characters printed on both sides (see FIGS. 1 to 4). The trustee certificate 10 has trustee identification information and the first information printed on one side (front side 10A), and the second information is printed on the other side (the back side 10B). Furthermore, the beneficiary certificate 20 has beneficiary identification information and the first information printed on one side (front side 20A), and second information is printed on the other side (back side 20B).

According to this function, the organized trustee certification information (or the trustee certificate 10) and beneficiary certification information (the beneficiary certificate 20) are mailed to the person using the terminal that sent the mailing request. Additionally, according to this function, the printed trustee certification information (or the trustee certificate 10) and beneficiary certification information (the beneficiary certificate 20) are organized on the front and back sides of one sheet of paper.

### Modification Function

This function is executed in the following order (1) to (4) via the application program AP after the completion of the generation process (see S400 in FIG. 8) is notified by the notification function (see S500 in FIG. 8). Specifically, it is as follows.
(1) If there is a request to modify the trustee certification information from the trustor terminal 300A, send the modification request (see S810 and S820 in FIG. 8);
(2) Next, the reception function S100B receives the modification request input and transmitted to the trustor terminal 300A.
(3) Next, the generation function S400B modifies the beneficiary certification information based on the modification request.
(4) Next, the sending or browsing function S500B allows the trustee certification information and the beneficiary certification information modified based on the modification request, assuming that the date and time when the modification request was sent is modification date, to send or view to the trustor terminal 300A, the trustee terminal 300B, and the beneficiary terminal 300C after the beneficiary certification information is modified.

Note that in (1) above, if there is no request to modify the trustee certification information from the trustor terminal 300A, the process ends. Further, this function is executed after executing the basic function (see FIG. 6). The content of corrections made by this function is included in the second information.

According to this function, the modified contents are reflected in the trustee certification information (or the trustee certificate 10) and beneficiary certification information (the beneficiary certificate 20).

### Withdrawal Notification Function in Case of Money Trust

This function performs (1) and (2) below when a money trust is included in the contract for trust property and there is a withdrawal from the deposit account (see S910 in FIG. 10B).
(1) The management server 100 receives the withdrawal information of the deposit account via the communication network 400 from the deposit server 100C (see FIG. 10A) that manages the deposit account of the money trust (see S100C of FIG. 10B).
(2) Next, when the management server 100 receives the withdrawal information of the deposit account from the deposit server 100C, the notification function S500C notifies the withdrawal information to the trustor terminal 300A, trustee terminal 300B, and beneficiary terminal 300C. (see FIG. 10B).

In this case, the management server 100 can receive the withdrawal information of the deposit account using, for example, the deposit server 100C that manages the deposit account and an application service provider (ASP).

This function is executed after executing the basic function (see FIG. 6). The content of the withdrawal information by this function is included in the second information.

According to this function, when a money trust is included in the contract for trust property, withdrawal information from a deposit account is shared with each party involved.

The above is the description of this embodiment.

### Modification Examples

As described above, this embodiment has been described with reference to FIGS. 1 to 10B, but this embodiment is only an example of an embodiment included in the technical scope of the present invention. The technical scope of the present invention also includes, for example, a plurality of modified examples described below.

For example, in implementing each function, the management server 100 uses an application program AP to connect a personal number card to each terminal (the trustor terminal 300A and the trustee terminal 300B and set in a card reader (not shown)). The card is set to be operable only when the information on the card (on which personal authentication information is recorded) matches the registered information of the trustor or trustee registered in advance in the storage unit 120 of the management server 100.

If this modification is adopted, security will be strengthened.

In the above-described embodiment, as a premise for executing the reception function, the trustor U1 uses the trustor terminal 300A or the trustee U2 uses the trustee terminal 300B to display an interface UI displayed on the screen of each terminal to input information regarding trust assets. However, this input function may be performed using, for example, electronic data (scanned with a scanner and subjected to OCR processing) of the contract details written on the medium. Alternatively, the interface may make a voice inquiry so that the input user can input voice.

Furthermore, in the above-described embodiment, the system has been described in which the management server 100 and a plurality of user terminals 300A, 300B, and 300C can communicate with each other over the communication network 400 (see FIG. 5). However, for example, as a system using blockchain technology, a user other than the inputter may be able to issue an electronic certificate for contract details. Furthermore, a non-fungible token (NFT) may be acquired for this electronic certificate.

Furthermore, the modification function (see FIG. 8) causes certificates (the trustee certificate 10 and the beneficiary certificate 20) to be issued multiple times. Therefore, by changing the trust management systems CS and CSc of this embodiment and this modification to a system that uses blockchain technology as in the above modification, non-fungible tokens can be used for certificates issued multiple times. may be issued.

1. A trust management system, comprising:
a management server storing and managing trust property information including contract details information in its own storage unit, and connected to a communication network, the contract details information including (1) a trustor information regarding the trustor of trust property, (2) a trustee information regarding the trustee, (3) a beneficiary information regarding the beneficiary, and (4) the contract details of the trust property; and,
a program that is stored in the storage unit, is available to the management server, and enables information transmission between the management server and at least one of a trustor terminal used by the trustor, a trustee terminal used by the trustee, and a beneficiary terminal used by the beneficiary via the communication network,
wherein the program causes the management server to execute
a storage function that stores the trust property information and its reception date and time in the storage unit;
an extraction function that extracts, from the trust property information stored in the storage unit by the storage function, trustee identification information that identifies the trustee, beneficiary identification information that identifies the beneficiary, and trust property identification information that identifies the trust property from the trust property information;
a generation function that generates, assuming that each of which the reception date and time is contract date, trustee certification information including the trustee identification information and the trust property identification information, and beneficiary certification information including the beneficiary identification information and the trust property identification information from the trustee identification information, the beneficiary identification information, and the trust property identification information extracted by the extraction function;
a notification function that, after the generation function generates the trustee certification information and the beneficiary certification information, notifies the trustor terminal, the trustee terminal, and the beneficiary terminal of completion of generating by the generation function; and,
a transmission or browsing function that causes, after the completion is notified by the notification function, the trustee certification information, and the beneficiary certification information to be transmitted or viewed by a terminal that sent a transmission or browsing request, assuming that the reception date and time is the contract date via an application running on the trustor terminal, the trustee terminal, or the beneficiary terminal, in response to a transmission or viewing request sent from the trustor terminal, the trustee terminal, or the beneficiary terminal.

2. The trust management system according to claim 1, wherein
the trust property identification information is composed of first information regarding subject of the trust property and second information regarding other than the subject;
the generation function divides the trust property identification information into the first information and the second information, and generates the trustee certification information and the beneficiary certification information; and,
the sending or browsing function divides, respectively, the trustee certification information and the beneficiary certification information into (A) the trustee identification information, the first information, and the second information; and (B) the beneficiary identification information, the first information, and the second information, and allows the terminal that sent a sending or browsing request to send or view (A) the trustee identification information, the first information, and the second information; and (B) the beneficiary identification information, the first information, and the second information.

3. The trust management system according to claim 2,
wherein the program causes the management server to execute
a mailing function that prints the trustee certification information and beneficiary certification information using a printing machine, creates a trustee certificate and beneficiary certificate, and mails the trustee certificate and the beneficiary certificate to a location specified by the terminal that sent a mailing request, in response to the mailing request sent from the trustor terminal, the trustee terminal, and the beneficiary terminal via an application running on the trustor terminal, the trustee terminal, and the beneficiary terminal after the completion is notified by the notification function.

4. The trust management system according to claim 1,
the trust management system can transmit a modification request of the trustee certification information from the trustor terminal to the management server via an application running on the trustor terminal, the trustee terminal, and the beneficiary terminal after the completion is notified by the notification function,
wherein
the generation function modifies the beneficiary certification information based on the modification request; and,
the sending or browsing function allows the trustee certification information and the beneficiary certification information modified based on the modification request, assuming that the date and time when the modification request was sent is modification date, to send or view to the trustor terminal, the trustee terminal, and the beneficiary terminal after the beneficiary certification information is modified.

5. The trust management system according to claim 3,
wherein
the trustee certificate and the beneficiary certificate are each a piece of paper with characters printed on both sides, and,
the beneficiary certificate has the beneficiary identification information and the first information printed on one side, and the second information on the other side.

6. The trust management system according to claim 1,
wherein if the contract for the trust property includes a money trust, the management server can receive withdrawal information for the money trust from a deposit server that manages deposit account for the money trust via the communication network,
wherein when the management server receives the withdrawal information of the deposit account from the deposit server, the notification function notifies the trustor terminal, the trustee terminal, and the beneficiary terminal of the withdrawal information.

7. The trust management system according to claim 1,
Wherein the program is set to be operable only when information on a personal number card connected to the trustor terminal and the trustee terminal and set in a card reader matches registered information of the trustor or the trustee.
